(19) United States
(12) Patent Application Publication
(10) Pub. No.: US 2017/0297816 A1
(43) Pub. Date: Oct. 19, 2017

(54) Trash Press Device

(71) Applicants: Angela Esomeju, Cedar Park, TX (US); Onyedika Esomeju, Cedar Park, TX (US)

(72) Inventors: Angela Esomeju, Cedar Park, TX (US); Onyedika Esomeju, Cedar Park, TX (US)

(21) Appl. No.: 15/643,057

(22) Filed: Jul. 6, 2017

(51) Int. Cl. B65F 1/14

(52) U.S. Cl. CPC B65F 1/1405; B65F 2210/129; B65F 2210/162

(57) ABSTRACT

A trash press device to compress trash within a container may include a base portion having a bottom surface, a top surface and a side surface to connect the bottom surface to the top surface; an upward extending arm portion to connect to the base portion; and a horizontal extending panel to connect to the upward extending arm portion having a panel top surface, an opposed panel bottom surface and a panel side surface to connect the panel top surface with the panel bottom surface.

### FIELD OF THE INVENTION

The present invention relates to trash and more particularly to a trash press device.

### BACKGROUND

Trash may be placed in many types of containers including trash bins and trash receptacles. Generally, the users collect trash within a small container which may be stored within the dwelling. If a large object is placed in the small container, it may fill up very quickly which may result in multiple trips for disposal. When the small container is filled, it is transported outside and placed into a larger container which may be picked up by the waste disposal company on a regular basis. A common problem is that users typically fill these containers with trash without bothering to compress the trash within the trash receptacle. In order to increase the amount of trash within the trash receptacle, it may be necessary to compress the trash. This creates more room within the trash receptacle and may lower the center of gravity to prevent the trash container from spilling. Unfortunately, the users may compress the trash with their hands or feet which may be dangerous, because the user will not know what is in the trash receptacle. Glass and other types of foreign objects may lurk beneath the surface of the trash. Additionally, the trash is generally unsanitary which may spread germs and diseases to the unsuspecting user. A solution to this problem is certainly desirable.

### SUMMARY

A trash press device to compress trash within a container may include a base portion having a bottom surface, a top surface and a side surface to connect the bottom surface to the top surface; an upward extending arm portion to connect to the base portion; and a horizontal extending panel to connect to the upward extending arm portion having a panel top surface, an opposed panel bottom surface, and a panel side surface to connect the panel top surface with the panel bottom surface.

The trash press device may include a nest of trash press sheets, connected to the base portion.

The first trash press sheet may include a smaller circumference then a second trash press sheet or pad.

The first trash press device may include a tab.

### BRIEF DESCRIPTION OF THE DRAWINGS

The invention may be understood by reference to the following description taken in conjunction with the accompanying drawings, in which, like reference numerals identify like elements, and in which:

FIG. 1a-b illustrates a perspective view of the trash press device of the present invention;

FIG. 2a-b illustrates a bottom view of the trash press device of the present invention;

FIG. 3a-b illustrates a different embodiment of the trash press device of the present invention;

FIG. 4a-b illustrates a top view of the trash press device of the present invention;

FIG. 5a-b illustrates a bottom view of a different embodiment of the trash press device of the present invention;

FIG. 6 illustrates a different embodiment of the trash press device of the present invention;

FIG. 7 illustrates a front and back view of the trash press device of the present invention;

FIG. 8a-b illustrates a top view of trash press sheets of the present invention;

FIGS. 9a-b illustrates a side view of the trash press sheets of the present invention;

FIGS. 10a-b illustrates a top view of the removable adhesive for the trash press sheets of the present invention;

FIGS. 11a-b illustrates a detailed view of the trash press sheets of the present invention;

FIG. 12 illustrates a front view of the trash press device of the present invention;

FIG. 13 illustrates a back view of the trash press device of the present invention;

FIG. 14 illustrates a side view of the trash press device of the present invention;

FIG. 15 illustrates the trash press connected to a trash receptacle;

FIG. 16 illustrates the trash press connected to the trash receptacle.

### DETAILED DESCRIPTION

The present invention compresses, shrinks and reduces the volume and or size of the trash, refuse, waste or any other type of product in a container of a trash or recycling receptacle. The present invention helps to prevent trash overflow and spills. The trash press device of the present invention may eliminate the need to press down on trash by hand or by foot. The present invention creates extra space in the trash receptacle and may provide for easy griping of a bag to remove it from the trash receptacle. The present invention saves time and frustration. Trash may be is leaves, garbage by the compression of food, recyclable trash any man-made and natural materials or any other types of things disposed.

The trash press of the present invention provides an easy and convenient way to compress trash without contaminating or exposing the hands or feet. The trash press may be formed from metal, iron, plastic or other suitable material or a combination of suitable materials and may include a planar, corrugated surface on one side and a detachable or fixed handle on the other side. The handle may be formed in different styles including a knob or straight edged handle. The trash press may be placed on the top of the trash receptacle or bin to compress the contents of the receptacle or bin. The handle may include rubber griping grooves, and the device may have an band such as a hand or foot strap formed from rubber, plastic or other suitable material or a combination of suitable materials to cover a portion of the hand or foot to facilitate removing the device from the trash bin or container after using the trash press. The device may have a hook for convenient hanging in storage when not in use.

The trash press of the present invention may include detachable/mountable pads which may be positioned on the bottom surface of the trash press. The trash press may be packaged with a trash bin or may be separately packaged.

The detachable pads may be positioned on the bottom surface of the trash press with a detachable adhesive to allow the detachable pads to be individually removed from the bottom surface of the trash press in order to provide a fresh detachable pad after the bottom detachable pad has been contaminated.

The trash press may include a fastener to facilitate holding trash bag liners in place.

The trash press may include a fastener to fasten to a device to clean or sterilize the trash press device or may be placed in a protective apparatus to protect, cover or clean or sterilize the trash press device.

A handle of the trash press may be sufficiently shaped to hang the trash press directly over the rim of an open container.

The handle of the trash press may include an aperture to allow the handle to be hung up directly into a wall, the unit or container.

The trash press may include a detachable cover to cover or protect the trash press of the present invention.

The trash press may include a fastener to attach to a device to odorize, freshen and or alter the smell of the contents in the trash container for the trash bin.

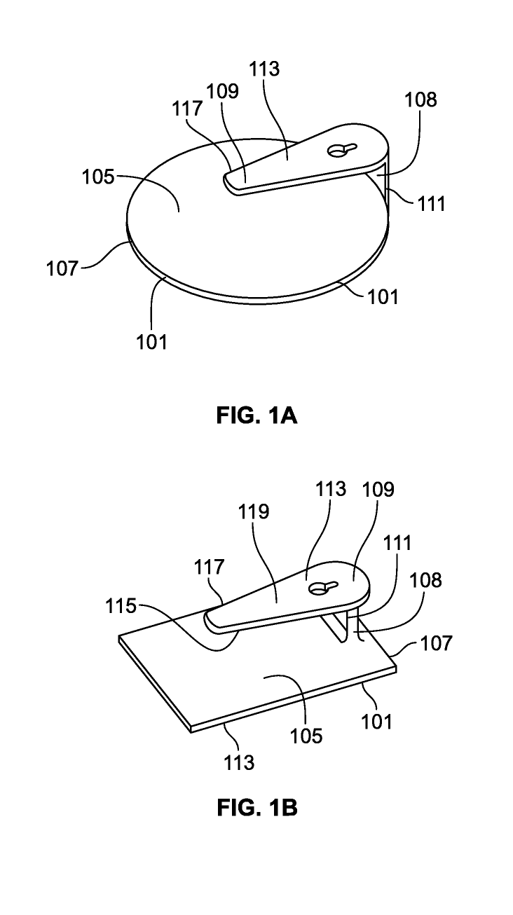

FIG. 1a illustrates the trash press device 100 of the present invention which may include a base portion 101 having a bottom surface 103 which may be opposed to a top surface 105 which may be connected to a peripheral side surface 107 which may connect to the bottom surface 103. The base portion 101 may be connected to a handle portion 108 which may include a planar horizontal extending panel 109 and a upward extending arm 111 which may connect the base portion 101 with the planar horizontal extending panel 109. The base portion 101 may be oval for circular (as shown). The horizontal extending panel 109 may include a panel top surface 113 which may be planar, an opposed panel bottom surface 115 which may be connected to the panel top surface 113 by a panel side surface 117 which may extend around the periphery of the horizontal extending panel 109.

The horizontal extending panel 109 may include a flexible strap 119 as shown in FIG. 1b which may extend across the horizontal extending panel to engage a hand or a foot of the user to provide stability.

FIG. 1b illustrates the trash press device 100 of the present invention which may include a base portion 101 having a bottom surface 103 which may be opposed to a top surface 105 which may be connected to a peripheral side surface 107 which may connect to the bottom surface 103. The base portion 101 may be connected to a handle portion 108 which may include a planar horizontal extending panel 109 and an upward extending arm 111 which may connect the base portion 101 with the planar horizontal extending panel 109. The base portion 101 may be rectangular (as shown). The horizontal extending panel 109 may include a panel top surface 113 which may be planar, an opposed panel bottom surface 115 which may be connected to the panel top surface 113 by a panel side surface 117 which may extend around the periphery of the horizontal extending panel 109.

The horizontal extending panel 109 may include a flexible strap 119 as shown in FIG. 1b which may extend across the horizontal extending panel to engage a hand or a foot of the user to provide stability.

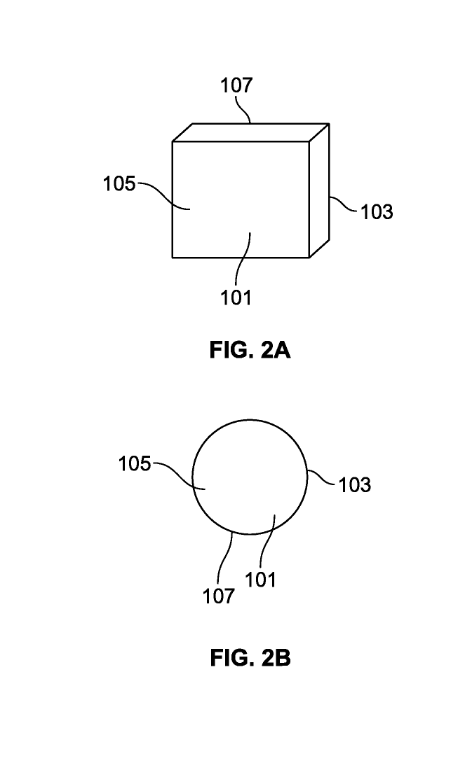

FIG. 2a illustrates the base portion 101 which may include a bottom surface 103 which may be opposed to a top surface 105 and may be connected to the bottom surface 103 by a side surface 107. The base portion 101 may be circular.

FIG. 2b illustrates the base portion 101 which may include a bottom surface 103 which may be opposed to a top surface 105 and may be connected to the bottom surface 103 by a side surface 107. The base portion 101 may be rectangular.

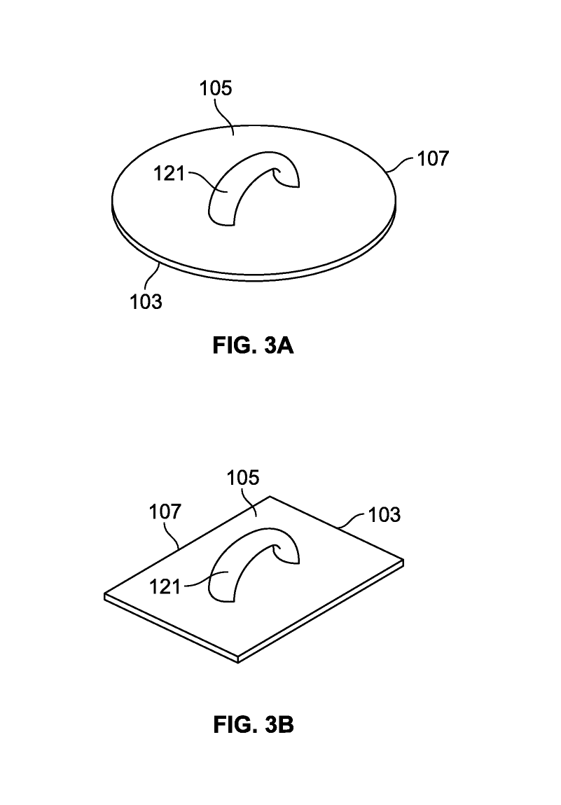

FIG. 3a illustrates the base portion 101 which may include a bottom surface 103 which may be opposed to a top surface 105 and may be connected to the bottom surface 103 by a side surface 107. The base portion 101 may be rectangular. A C-shaped handle 121 is connected to the base portion 101. Other shapes are within the scope of the invention.

FIG. 3b illustrates the base portion 101 which may include a bottom surface 103 which may be opposed to a top surface 105 and may be connected to the bottom surface 103 by a side surface 107. The base portion 101 may be circular. A C-shaped handle 121 is connected to the base portion 101. Other shapes are within the scope of the invention.

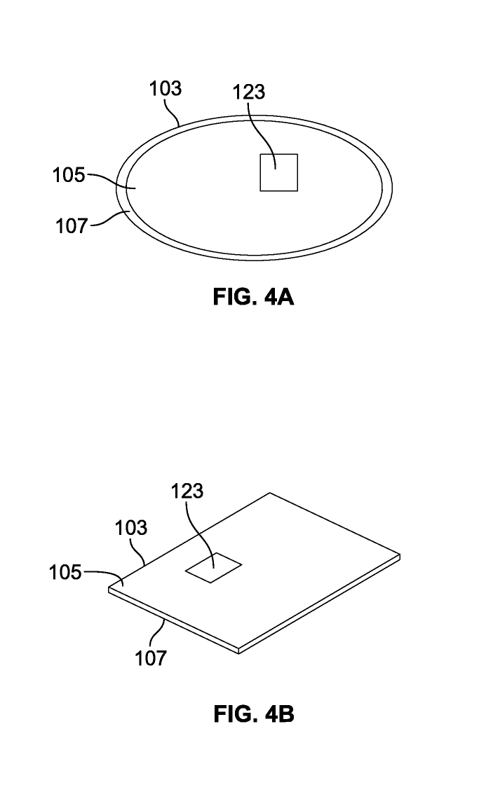

FIG. 4a illustrates the base portion 101 which may include a bottom surface 103 which may be opposed to a top surface 105 and may be connected to the bottom surface 103 by a side surface 107. The base portion 101 may be rectangular. A [symbol] -shaped handle 123 is connected to the base portion 101. Other shapes are within the scope of the invention.

FIG. 3b illustrates the base portion 101 which may include a bottom surface 103 which may be opposed to a top surface 105 and may be connected to the bottom surface 103 by a side surface 107. The base portion 101 may be circular. A knob-shaped handle 123 is connected to the base portion 101. Other shapes are within the scope of the invention.

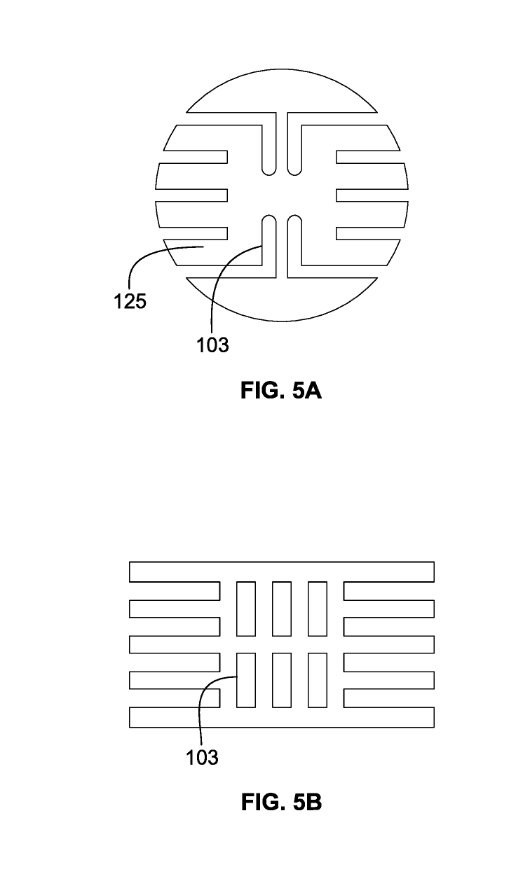

FIG. 5a illustrates the bottom surface 103 of the bottom portion 101 which may include detachable pads 125 nondestructively detachably connected to the bottom surface. The bottom portion 101 may be circular or other appropriate shape.

FIG. 5b illustrates the bottom surface 103 of the bottom portion 101 which may include detachable pads 125 nondestructively detachably connected to the bottom surface. The bottom portion 101 may be circular or other appropriate shape.

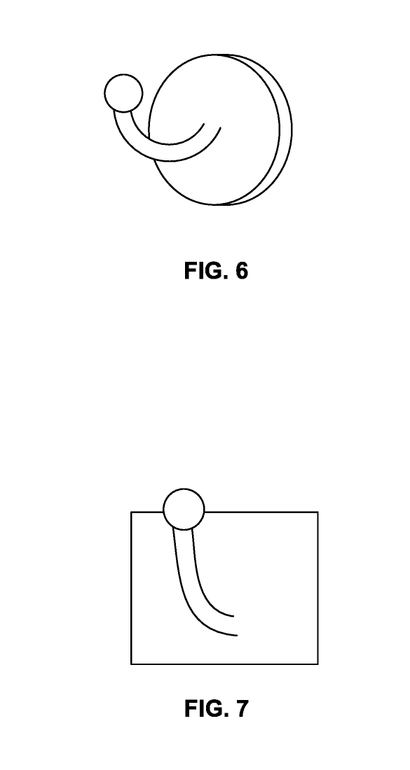

FIGS. 6 and 7 illustrates a perspective view of another embodiment of the trash press device 100 of the present invention. FIG. 6 illustrates a base portion which may be disk shaped and may include hook device 131 which may be used to attach to a trash receptacle. FIG. 7 illustrates a base portion which may be rectangular shaped and may include a hook device 131 which may be used to attach to a trash receptacle.

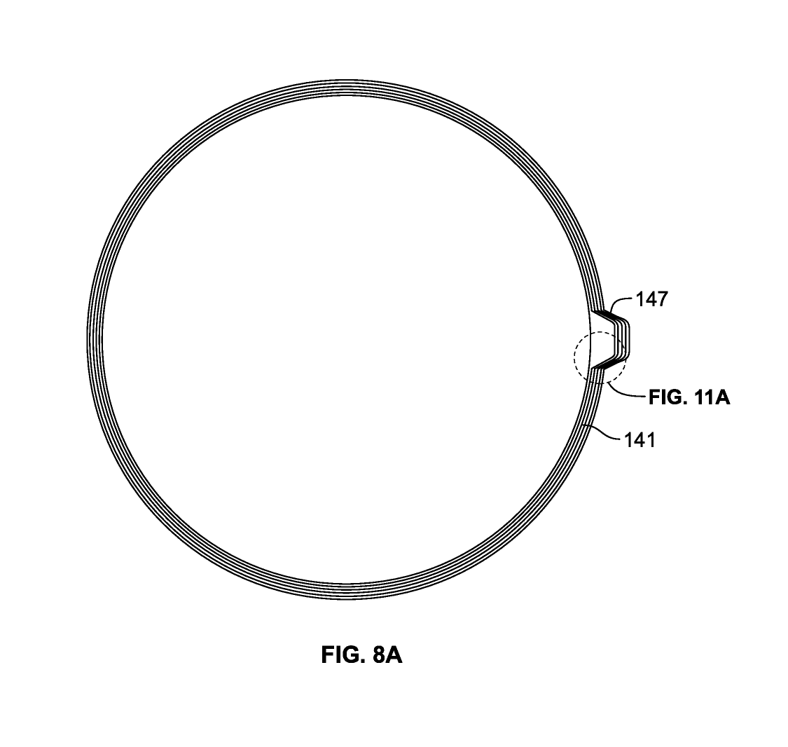

FIG. 8a illustrates a top view of layers of trash press sheets 141 which may be nested by having a successor trash press sheet 141 being smaller in circumference (or the same size) then the trash press sheet 141 directly underneath. Although the size of the trash press sheet 141 may vary with respect to successive trash press sheets 141, the trash press sheets 141 may be a substantial mirror of another trash press sheet 141. The trash press sheet 141 may include at least one of the cleaning material, the deodorizing material or other material to aid in the trash pressing process. The trash press sheets 141 may be substantially disk shaped. The trash press sheet 141 may include a tab 147 which may extend radially in order to provide a grasping point for the user to remove a trash press sheet 141.

FIG. 8b illustrates a top view of layers of trash press sheets 143 which may be nested by having a successor trash press sheet 143 being smaller in circumference then the trash press sheet 143 directly underneath. Although the size of the trash press sheet may vary with respect to successive trash press sheets 143, the trash press sheets 143 may be a substantial mirror of another trash press sheet 143. The trash press sheet 143 may include at least one of the cleaning material, the deodorizing material or other material to aid in the trash pressing process. The trash press sheets 143 may be substantially rectangular. The trash press sheet 143 may include a tab 147 which may extend outwards in order to provide a grasping point for the user to remove a trash press sheet 143.

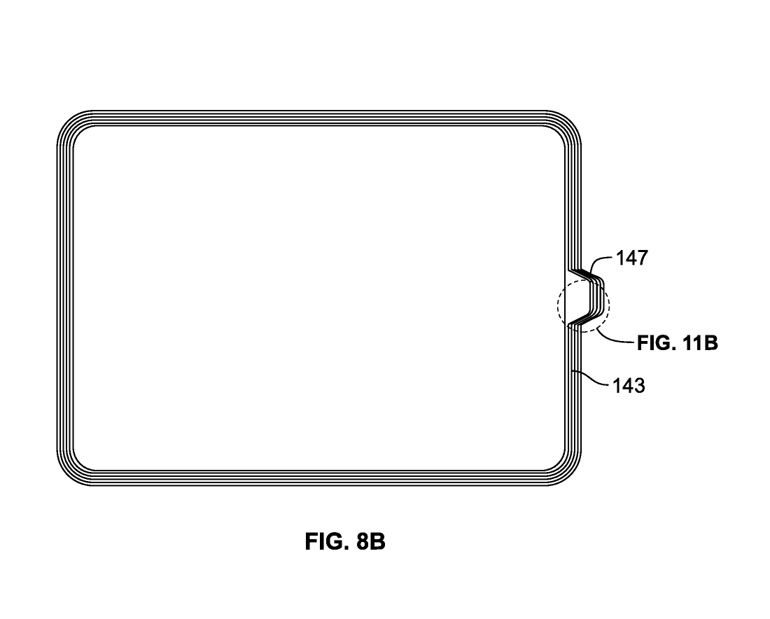

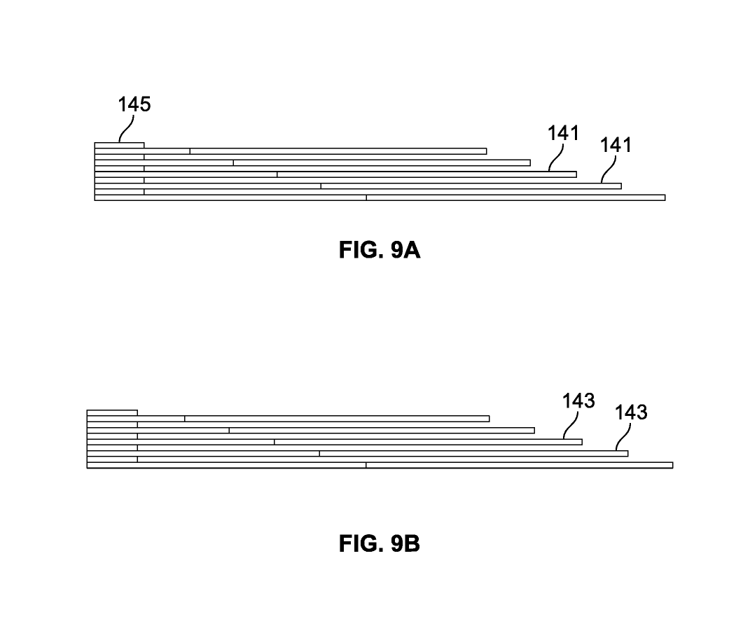

FIG. 9a illustrates a side view of the nest of trash press sheets 141 which may include a layer 145 of detachable/removable adhesive between each of the trash press sheets 141. The layer 145 of adhesive may retain the nest of trash press sheets 141 until the user press the tab 147 and separates a first trash press sheet 141 from a second trash press sheet 141.

FIG. 9b illustrates a side view of the nest of trash press sheets 143 which may include a layer 145 of detachable/removable adhesive between each of the trash press sheets 143. The layer 145 of adhesive may retain the nest of trash press sheets 143 until the user press the tab 147 and separates a first trash press sheet 143 from a second trash press sheet 143.

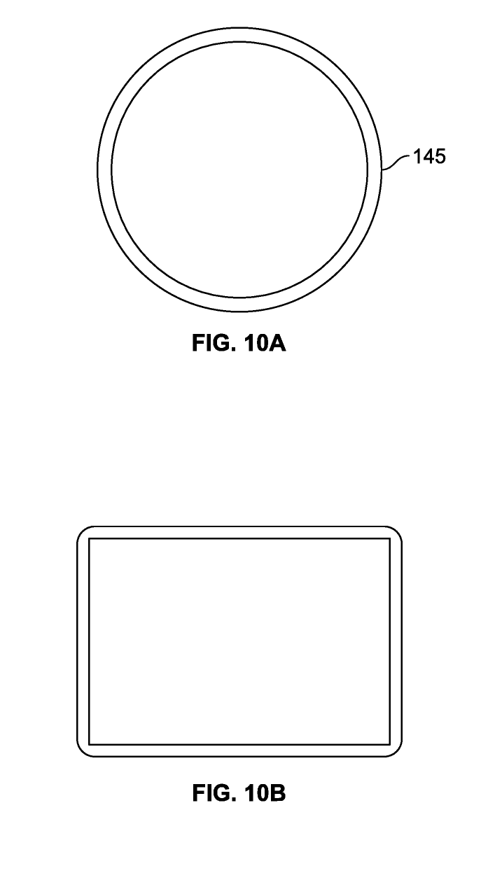

FIG. 10a illustrates a top view of adhesive 145 which may extend around the outer periphery of the trash press sheet 141.

FIG. 10b illustrates a top view of adhesive 145 which may extend around the outer periphery of the trash press sheet 143.

FIGS. 11a and 11b show a detail of the tab 147.

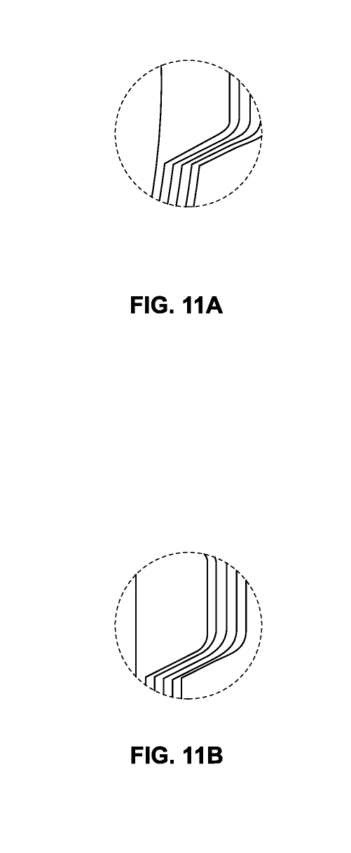

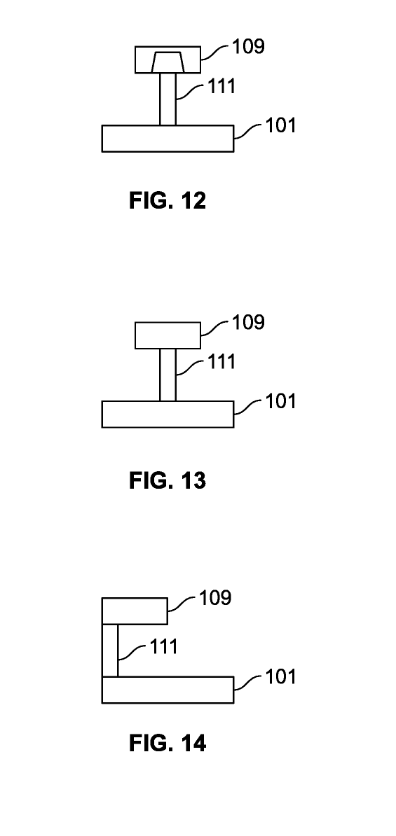

FIG. 12 illustrates a front view of the trash press device 100 which may include a base portion 101, a horizontal extending panel 109 and an upward extending arm portion 111.

FIG. 13 illustrates a back view of the trash press device 100 which may include a base portion 101, a horizontal extending panel 109 and an upward extending arm portion 111.

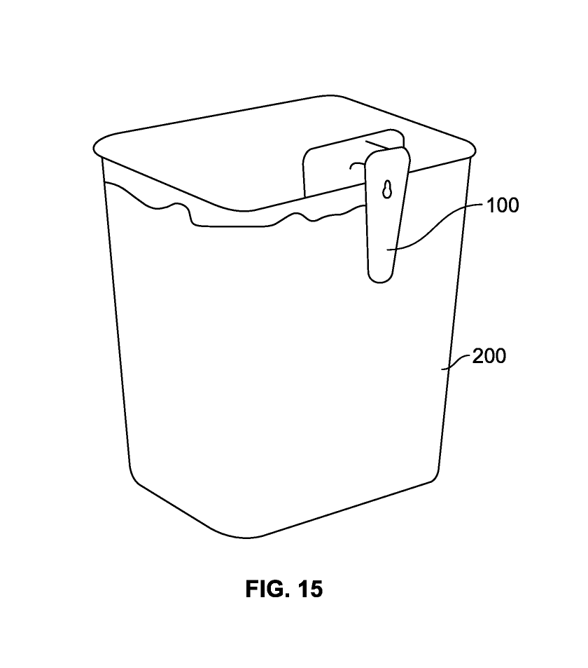

FIG. 14 illustrates a side view of the trash press device 100 which may include a base portion 101, a horizontal extending panel 109 and a upward extending arm portion 111.

FIG. 15 illustrates a trash receptacle 200 which may be in a shape including a rectangle, circle or oval being connected to the trash press device 100 of the present invention.

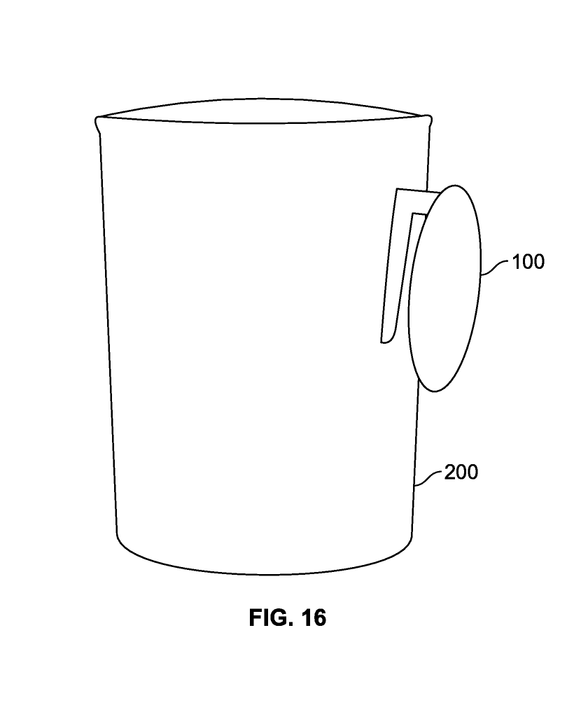

FIG. 16 illustrates a perspective view of a trash receptacle 200 having an exterior surface connected to the trash press device 100 of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1) A trash press device to compress trash within a container, comprising:
a base portion having a bottom surface, a top surface and a side surface to connect the bottom surface to the top surface;
an upward extending arm portion to connect to the base portion; and
a horizontal extending panel to connect to the upward extending arm portion having a panel top surface, an opposed panel bottom surface and a panel side surface to connect the panel top surface with the panel bottom surface.

2) A trash press device to compress trash within a container as in claim 1, wherein the trash press device includes a nest of trash press sheets connected to the base portion.

3) A trash press device to compress trash within a container as in claim 2, wherein a first trash press sheet has a smaller circumference than a second trash press sheet.

4) A trash press device to compress trash within a container as in claim 3, wherein the first trash press sheet includes a tab.

5) A trash press device to compress trash within a container as in claim 1, wherein the trash press is attached to a receptacle.

6) A trash press device to compress trash within a container as in claim 1, wherein the trash press is attached to a receptacle by a handle.

7) A trash press device to compress trash within a container as in claim 1, wherein the trash press is covered by a cover.

8) A trash press device to compress trash within a container as in claim 1, wherein the trash press includes a nest of sheets varying in size.

9) A trash press device to compress trash within a container as in claim 1, wherein the trash press includes material to odorize waste.

10) A trash press device to compress trash within a container as in claim 1, wherein the trash press is formed from metal.

11) A trash press device to compress trash within a container as in claim 1, wherein the trash press is formed from iron.

12) A trash press device to compress trash within a container as in claim 1, wherein the trash press is formed from plastic.

13) A trash press device to compress trash within a container as in claim 1, wherein the trash press is formed from a combination of materials.

14) A trash press device to compress trash within a container as in claim 1, wherein the trash press includes a planar corrugated surface.

15) A trash press device to compress trash within a container as in claim 1, wherein the handle is detachable.

16) A trash press device to compress trash within a container as in claim 1, wherein the handle is fixed.

17) A trash press device to compress trash within a container as in claim 1, wherein the handle is a knob.

18) A trash press device to compress trash within a container as in claim 1, wherein the handle includes a straight edge.

19) A trash press device to compress trash within a container as in claim 1, wherein the handle includes rubber griping grooves.

20) A trash press device to compress trash within a container as in claim 1, wherein the handle includes a hand strap.

21) A trash press device to compress trash within a container as in claim 1, wherein the handle includes a foot strap.

22) A trash press device to compress trash within a container as in claim 1, wherein the handle includes a strap formed from rubber.

23) A trash press device to compress trash within a container as in claim 1, wherein the handle includes a strap formed from plastic.

24) A trash press device to compress trash within a container as in claim 1, wherein the handle includes a strap formed from a combination of materials.

25) A trash press device to compress trash within a container as in claim 1, wherein the trash press includes a hook for storage.

26) A trash press device to compress trash within a container as in claim 1, wherein the trash press includes detachable/mountable pads

27) A trash press device to compress trash within a container as in claim 1, wherein the trash press includes a pad positioned on the bottom surface of the trash press.

28) A trash press device to compress trash within a container as in claim 1, wherein the trash press may be packaged with a receptacle.

29) A trash press device to compress trash within a container as in claim 1, wherein the bottom surface of the trash press includes a pad attached with detachable adhesive.

30) A trash press device to compress trash within a container as in claim 1, wherein the trash press a fastener to facilitate trash bag liners.
